(19) United States
(12) Patent Application Publication
(10) Pub. No.: US 2023/0175916 A1
(43) Pub. Date: Jun. 8, 2023

(54) IDENTIFYING ANOMALIES IN WELL-ENVIRONMENT FLEXIBLE PIPES

(71) Applicant: HALLIBURTON ENERGY SERVICES, INC., Houston, TX (US)

(72) Inventors: Ahmed Elsayed Fouda, Spring, TX (US); Aurel Adrian Popoviciu, Houston, TX (US)

(21) Appl. No.: 16/966,083

(22) PCT Filed: May 19, 2020
(86) PCT No.: PCT/US2020/033526

§ 371 Date: Jul. 30, 2020

Related U.S. Application Data
(60) Provisional application No. 62/975,493, filed on Feb. 12, 2020.

(51) Int. Cl. G01M 5/00; E21B 47/00; E21B 47/007

(52) U.S. Cl. CPC G01M 5/0025; G01M 5/0033; G01M 5/0075; G01M 5/0091; E21B 47/006; E21B 47/007; F16L 2101/30

(57) ABSTRACT

A system includes an electromagnetic inspection device, a processing device, and a memory device. The electromagnetic inspection device includes at least one transmitter that can transmit an electromagnetic signal toward a wall of a flexible pipe. The electromagnetic inspection device also includes at least one receiver that can receive at least one scattered electromagnetic signal from the wall of the flexible pipe. The memory device includes instructions executable by the processing device to cause the processing device to transmit an electromagnetic signal using the transmitter, to receive the scattered electromagnetic signal using the receiver, and to identify at least one anomaly in the wall of the flexible pipe using the scattered electromagnetic signal.

### CROSS-REFERENCE TO RELATED APPLICATION

This claims priority to U.S. Provisional Patent Application No. 62/975,493 filed on Feb. 12, 2020, titled “Electromagnetic Inspection of Metallic Layers of a Flexible Pipe,” the disclosure of which is hereby incorporated by reference in its entirety for all purposes.

### TECHNICAL FIELD

The present disclosure relates generally to inspection systems for a hydrocarbon-well environment and, more particularly (although not necessarily exclusively), to inspection systems for inspecting flexible pipes in the hydrocarbon-well environment.

### BACKGROUND

In offshore applications, flexible pipes are a type of pipeline that can be used to transport produced hydrocarbons or other fluids between subsea installations and topside facilities. Flexible pipes are commonly used as flowlines, risers, or jumpers. Flexible pipes can have a mix of metallic and non-metallic layers that seal the interior of the flexible pipe in a dynamic, offshore environment.

When flexible pipes are used in subsea environments, calculating their service life can be desirable. When submerged, flexible pipes can be exposed to harsh conditions that can result in corrosion, over-bending, cracks, or other anomalies in wall layers of the flexible pipe. In one or more examples, a calculated service life of the flexible pipes may differ from an actual life of a flexible pipe. For example, the corrosion, over-bending, cracks, or other anomalies in the flexible pipes resulting from exposure to harsh conditions may result in a shortened lifespan of the flexible pipe from the calculated service life.

### BRIEF DESCRIPTION OF THE DRAWINGS

FIG. 1 is a diagram of oil and gas offshore installations in a subaquatic environment according to one example of the present disclosure.

FIG. 2 is a schematic cutaway view of a flexible pipe according to one example of the present disclosure.

FIG. 3 is a cross-sectional schematic view of layers of a flexible pipe according to one example of the present disclosure.

FIG. 4A is a schematic view of a riser with an in-line inspection device within a flexible pipe according to one example of the present disclosure.

FIG. 4B is a detailed, schematic view of the in-line inspection device within the flexible pipe of FIG. 4A according to one example of the present disclosure.

FIG. 5 is a schematic view of an electromagnetic signal generated by the in-line inspection device of FIGS. 4A and 4B within the flexible pipe of FIG. 2 according to one example of the present disclosure.

FIG. 6 is a flowchart of a process to identify anomalies in flexible pipes according to one example of the present disclosure.

FIG. 7A is a top-level schematic view of an in-line inspection device according to one example of the present disclosure.

FIG. 7B is a schematic view of an in-line inspection device with a set of transmitters and receivers according to one example of the present disclosure.

FIG. 8 is a schematic view of a transmitter and at least one receiver on an in-line inspection device according to one example of the present disclosure.

FIG. 9 is an example of the in-line inspection device of FIG. 7 and outputs from the in-line inspection device including an indication of an anomaly in a wall of a flexible pipe according to one example of the present disclosure.

FIG. 10 is an example output graph of the in-line inspection device of FIG. 7 including multiple indications of anomalies in various metallic layers in a wall of a flexible pipe according to one example of the present disclosure.

FIG. 11 is a schematic view of a computing system of an in-line inspection device according to one example of the present disclosure.

### DETAILED DESCRIPTION

Certain aspects and examples of the present disclosure relate to inspecting a set of layers of a wall of a flexible pipe in a hydrocarbon well environment. A flexible pipe may be a conduit for transporting a hydrocarbon fluid or other well fluids. The flexible pipe may be constructed as a set of layers, and the layers can include metallic armor layers, insulating polymeric layers, a combination of the metallic armor layers and the insulating polymeric layers, or polymeric layers with integrated metallic armor. The flexible pipe may include a polymeric outer seal, which prevents seawater interaction with the layers of the wall of the flexible pipe or with the hydrocarbon fluid or the other well fluids within the flexible pipe. The other fluids may include injection fluids, control fluids, or other fluids provided to the wellbore or subsea installations from the topside facilities or produced by the wellbore.

The flexible pipe can be exposed to harsh conditions in a hydrocarbon well environment that may lead to corrosion, over-bending, cracks, or other anomalies. It may be desirable to calculate an accurate service life of the flexible pipe. The accurate service life of the flexible pipe may provide a prediction of when the flexible pipe may need to be repaired or replaced. Calculating the accurate service life of the flexible pipe may require an enhanced inspection operation. The enhanced inspection operation may include inspecting a set of layers of a wall of the flexible pipe. Inspecting the layers of the wall of the flexible pipe may provide early detection of corrosion, over-bending, cracks, or other anomalies. The enhanced inspection may be completed by an in-line inspection device.

The in-line inspection device may be any device or tool that can be positioned inside a flexible pipe for performing inspections from within the flexible pipe. In some examples, some sections of the flexible pipe are underwater or buried under a subterranean surface. Examples of the in-line inspection device may include free-swimming smart pigs, tethered pigs, robotic pigs, as well as other devices and tools that can be positioned inside the flexible pipe for performing inspections of the flexible pipe from within the flexible pipe. A pig may be a device used to perform tubing or wellbore inspection tasks. A free-swimming smart pig can be a device that moves along the flexible pipe along with a flow of central bore fluid to conduct the inspection tasks. A tethered pig can be tethered to a well platform using an umbilical, and the tethered pig can conduct the inspection tasks from within the flexible pipe. In an example, the umbilical can control the tethered pig along the flexible pipe to allow the tethered pig to conduct the inspection tasks. A robotic pig can include a self-propulsion unit that enables the robotic pig to move along the flexible pipe autonomously to conduct the inspection tasks. The in-line inspection device may be able to inspect multiple metallic layers of the flexible pipe. Inspection of the flexible pipe with the in-line inspection device may avoid the halt of production flow and avoid a risk of damage to the flexible pipe.

The in-line inspection device may include an electromagnetic pipe inspection tool. The electromagnetic pipe inspection tool can be a time-domain tool or a frequency-domain tool with a set of transmitters and a set of receivers. For the time-domain tool, the transmitters and the receivers may be collocated, and the transmitters and the receivers may acquire different time-channel measurements. The transmitters and the receivers can be transceivers. The frequency-domain tool may include the transmitters and the receivers, which can be positioned separately to transmit and record a set of channels. The channels can be at a set of frequencies that may provide enough information to determine a radial position and an amount of metal loss of each layer of the flexible pipe.

In some examples, tethered, free-swimming, or robotic versions of the in-line inspection device can be remotely operated through an umbilical or wireless link from a graphical user interface of a control system located outside of the flexible pipe, such as at the surface. Inspection data can be transferred in real time and can be presented in 2D or 3D color maps. Processing algorithms can be applied to enhance response features of particular interest.

Various examples can be developed to employ a time-frequency spectrogram to process frequency domain eddy current measurements for inspecting and monitoring a flexible pipe. The inspection of the flexible pipe can include a determination as to whether defects originate within inner or outer layers of the flexible pipe in a concentric arrangement. The inspection can also provide an estimate of radial distance from the defects of the flexible pipe to the sensors of the in-line inspection device. Sensors may include multiple receivers at different spacings from one or more transmitters to provide multiple radial depths of investigation. The sensors may operate at different frequencies where higher frequencies (e.g., 50 Hz-1000 Hz) provide higher sensitivity to innermost metallic layers of the flexible pipe and lower frequencies (e.g., below 50 Hz) provide higher sensitivity to the outermost metallic layers of the flexible pipe. Estimates of a length of the defects may also be provided by the inspection techniques. Further, in some examples, it is possible to have real-time processing for continuous operation and visualization while logging.

An electromagnetic inspection method may include inspecting for multiple anomalies such as deformations, metal loss, cracks, eccentricity, etc. Further, the method may include inspecting for anomalies at multiple layers of the flexible pipe in one run. The method may also include implementation in a stand-alone tool or attached to another in-line inspection device. Further, the method may include a cost-effective inspection such as an inspection that does not rely on pipeline shutdown or multiple inspection runs. The electromagnetic inspection method may apply to various types of flexible pipelines such as gas and liquid flexible pipelines, high and low pressure flexible pipelines, etc. Measurement accuracy may not be affected by the internal or external pipeline coating, and inspection can be done on both ferromagnetic and non-ferromagnetic conductive layers. The flexible pipe anomalies may be inspected using accurate High-Definition Frequency variance algorithms of returning electromagnetic waves.

Inversion may use a computer model of the pipe layers and can iteratively refine the properties of the layers of the flexible pipe, such as outer diameter, thickness, electrical conductivity, magnetic permeability, and eccentricity among layers. Pre-known information on the structure of the pipe can be used to constrain model parameters. The pre-known information may include a number of layers, a nominal diameter of each layer, a type of metal being ferromagnetic versus non-ferromagnetic, etc. Monitoring pipe integrity can be done in time-lapse fashion to calculate a rate of metal loss and implement mitigation plans before failures occur.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

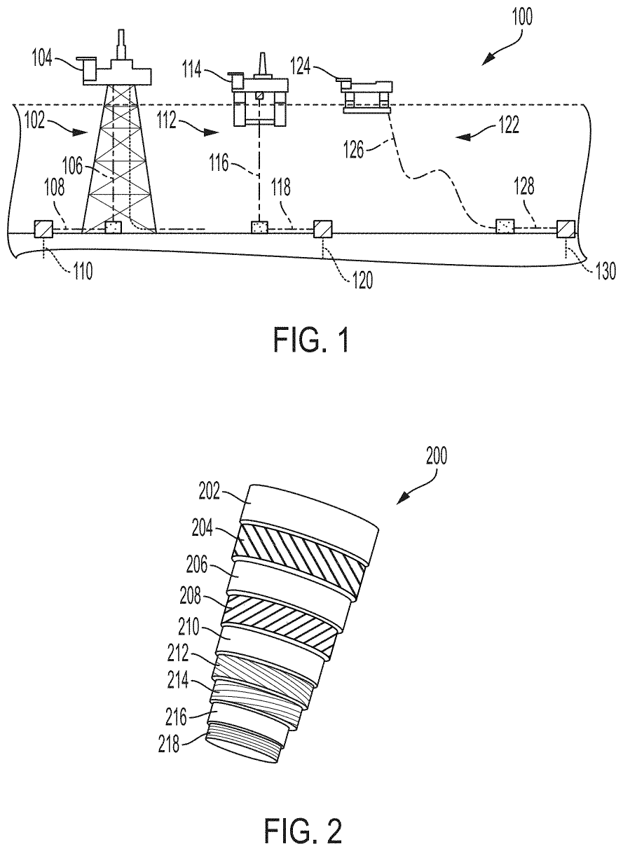

FIG. 1 is a diagram of examples of oil and gas offshore installations 100 according to one example of the present disclosure. An example of a hydrocarbon well system 102 can include a supported platform 104 that is constructed from a seabed. The supported platform 104 can be coupled to a supported riser 106. The supported riser 106 can be coupled to a pipeline 108, which can be coupled to a wellbore 110. As illustrated, the supported riser 106 may be a flexible pipe that includes layers of metallic armor and layers of non-metallic material, such as a polymeric material. In one or more examples, the supported riser 106 and the pipeline 108 may prove a transport path for materials pumped into the wellbore 110 or for materials produced from the wellbore 110.

In another example, a hydrocarbon well system 112 can include a floating platform 114 that is coupled to a tensioned riser 116. The tensioned riser 116 can be coupled to a pipeline 118, which can be coupled to a wellbore 120. As illustrated, the tensioned riser 116 may be a flexible pipe that includes layers of metallic armor and layers of non-metallic material.

In an additional example, a hydrocarbon well system 122 can include a floating platform 124 that can be coupled to a floating riser 126. The floating riser 126 can be coupled to a pipeline 128, which can be coupled to a wellbore 130. As illustrated, the floating riser 126 may be a flexible pipe that includes layers of metallic armor and layers of non-metallic material.

FIG. 2 is a schematic cutaway view of a flexible pipe 200 according to one example of the present disclosure. The flexible pipe 200 may be sealed with an outer layer of polymer, which may be referred to as a polymeric sheath 202. The flexible pipe 200 may include a set of metallic layers such as an outer layer of tensile armor 204, an inner layer of tensile armor 208, a layer of back-up pressure armor 212, a layer of interlocked pressure armor 214, and a carcass layer 218. Polymeric, or otherwise insulating, layers of the flexible pipe 200 may be positioned between the metallic layers. For example, the polymeric layers may include anti-wear sheaths 206 and 210 and an internal pressure sheath 216.

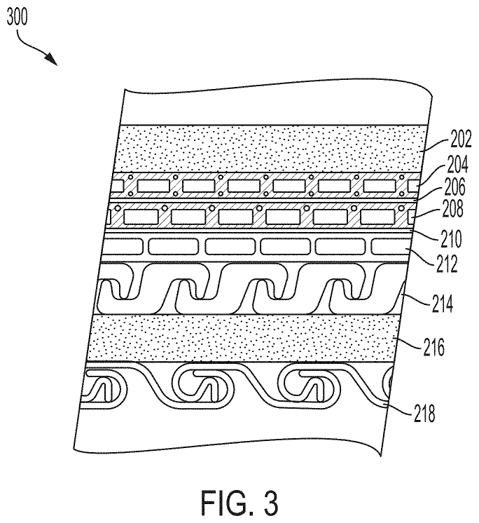

FIG. 3 is a cross-sectional schematic view of a wall 300 of the flexible pipe 200 according to one example of the present disclosure. The wall 300 depicts examples of material used for a set of layers of the flexible pipe 200. As discussed above with respect to FIG. 2, an outer sealing layer may be referred to as the polymeric sheath 202. The polymeric sheath 202 can seal the flexible pipe 200 and may prevent interaction of seawater with fluids travelling within the flexible pipe 200 or with other layers of the flexible pipe 200. The wall 300 of the flexible pipe 200 may also include the metallic layers. The metallic layers may include the outer layer of tensile armor 204, the inner layer of tensile armor 208, the layer of back-up pressure armor 212, the layer of interlocked pressure armor 214, and the carcass layer 218. The metallic layers may increase durability or increase lifetime of the wall 300 of the flexible pipe 200.

The wall 300 of the flexible pipe 200 may also include a set of non-metallic layers such as polymeric, or otherwise insulating, layers, and the non-metallic layers may be positioned between the metallic layers. Some examples of the non-metallic layers can include anti-wear sheaths 206 and 210, and the internal pressure sheath 216. The non-metallic layers may reduce wear on the metallic layers in the wall 300 of the flexible pipe 200 or the non-metallic layers may also increase bending radius of the flexible pipe 200.

Other arrangements of the layers of the flexible pipe 200 are also contemplated. For example, the wall 300 of the flexible pipe 200 may be constructed with at least one polymeric layer that includes metal integrated into the polymeric layer. At least one hybrid layer can include polymer that encapsulates a metallic portion of the hybrid layer.

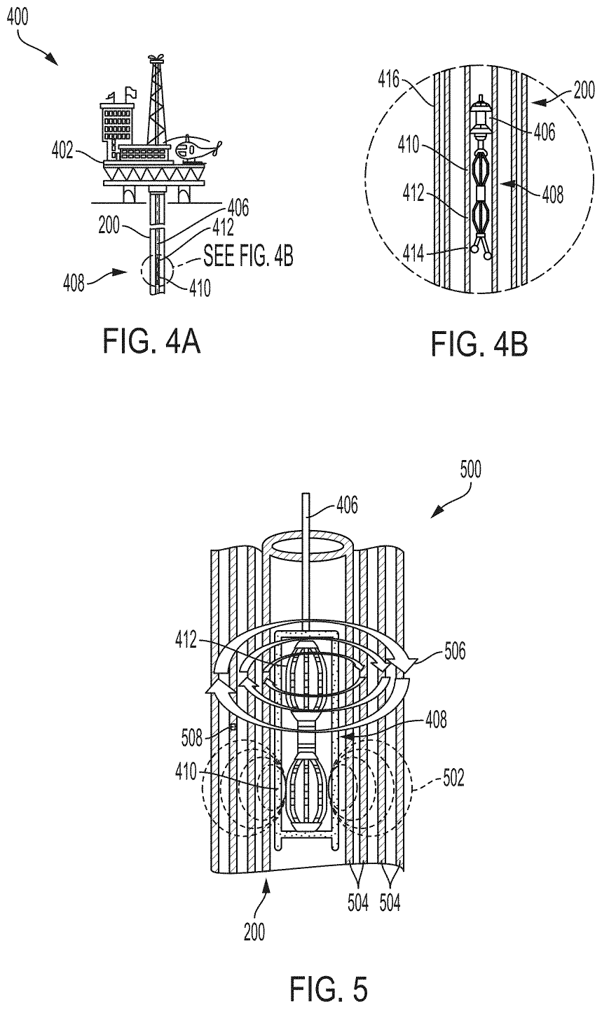

FIG. 4A is a schematic of an offshore system 400, and FIG. 4B is a detailed view of an in-line inspection device 408 that can be positioned in the flexible pipe 200 of the offshore system 400 according to one example of the present disclosure. The flexible pipe 200 can be coupled to a platform 402. In an example, an umbilical 406 can be coupled to the platform 402, and the umbilical 406 can also be coupled to an in-line inspection device 408. The in-line inspection device 408 can be positioned within the flexible pipe 200. A set of transmitters 410 and a set of receivers 412 can be positioned on the in-line inspection device 408. An odometer 414 can be positioned on the in-line inspection device 408 to track a location of the in-line inspection device 408 while positioned within the flexible pipe 200. In other examples, an in-line inspection device can be used in conjunction with a different electromagnetic inspection device positioned on the outside of the flexible pipe 200.

The transmitters 410 can transmit an electromagnetic signal toward a set of layers of the flexible pipe 200. In an example, an anomaly 416 can scatter the electromagnetic signal to generate a scattered electromagnetic signal. The receivers 412 can receive the scattered electromagnetic signal. An analysis of the scattered electromagnetic signal can result in identification of the anomaly 416.

FIG. 5 is a schematic view 500 of an electromagnetic signal 502 generated by the in-line inspection device 408 within the flexible pipe 200 according to one example of the present disclosure. An umbilical 406 can be coupled to the in-line inspection device 408, and the umbilical 406 can enable movement of the in-line inspection device 408 within the flexible pipe 200. The transmitters 410 and the receivers 412 can be positioned on the in-line inspection device 408.

In an example, the transmitters 410 can transmit the electromagnetic signal 502 toward metallic layers 504 of the flexible pipe 200. An anomaly 508 on a metallic layer 504 may cause the electromagnetic signal 502 to scatter and generate a scattered electromagnetic signal 506. The anomaly 508 can include metal loss, eccentricity, deformation, or other damage to the flexible pipe 200. The scattered electromagnetic signal 506 can be detected by the receivers 412. In an example, the scattered electromagnetic signal 506 may be generated by an eddy current induced on a metallic layer of the flexible pipe 200 from the introduction of the electromagnetic signal 502 by the transmitters 410. Because the scattered electromagnetic signal 506 may be generated from interactions between the electromagnetic signal 502 and the anomaly 508, the scattered electromagnetic signal 506 may be used to detect a location of the anomaly 508 in the metallic layers 504.

The in-line inspection device 408 may transmit the electromagnetic signals 502 at a frequency between 30 Hz and 1 kHz. In some examples, the value of the signal frequency can monotonically increase relative to a velocity of the in-line inspection device 408 travelling within the flexible pipe 200. The in-line inspection device 408 may utilize distinct signal frequencies to analyze each metallic layer of the flexible pipe 200. An innermost metallic layer of the flexible pipe 200 may be inspected at a highest frequency, while an outermost metallic layer of the flexible pipe 200 may be inspected at a lowest frequency. Locating the anomaly 508 in the flexible pipe 200 may include locating an azimuthal location of the anomaly 508 and a linear position of the anomaly 508 in the flexible pipe 200. The transmitters 410 of the in-line inspection device 408 may transmit an electromagnetic signal 502 covering multiple frequencies, such as a set of discrete frequencies or a spectrum of frequencies, that are selected to optimize interaction with the layers of the flexible pipe 200.

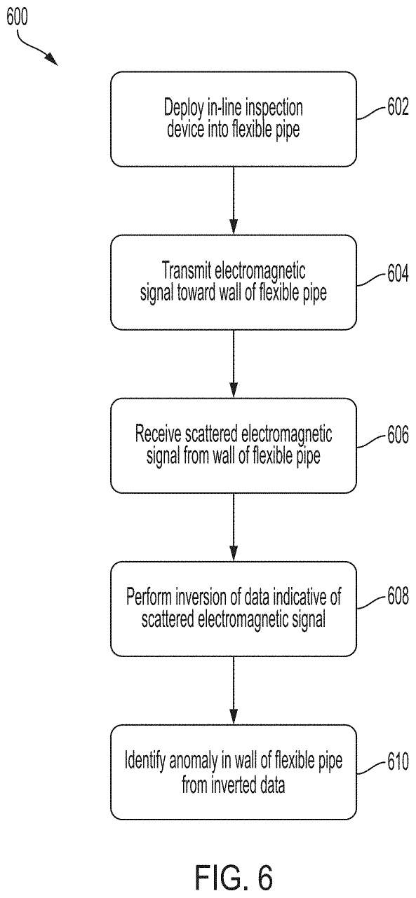

FIG. 6 is a flowchart of a process 600 to identify the anomaly 508 in a flexible pipe 200 according to one example of the present disclosure. At block 602, the process 600 involves deploying the in-line inspection device 408 into the flexible pipe 200. The in-line inspection device 408 can be positioned in the flexible pipe 200 as a tethered pig, a free-swimming smart pig, or as a robotic pig. In an example, the tethered in-line inspection device 408 can be coupled at a downhole end of the umbilical 406, which can be coupled to a platform 402. The free-swimming in-line inspection device 408 can move along the flexible pipe with a flow of central bore fluid. The robotic pig can include a self-propulsion unit that enables the in-line inspection device 408 to travel within the flexible pipe 200 without the umbilical 406 or other tool for positioning the robotic pig within the flexible pipe 200.

At block 604, the process 600 involves transmitting an electromagnetic signal 502 into the wall 300 of the flexible pipe 200 using one or more of the transmitters 410. The transmitters 410 can be positioned on the in-line inspection device 408. The anomaly 508 of the flexible pipe 200 can scatter the electromagnetic signal 502, which generates the scattered electromagnetic signal 506.

At block 606, the process 600 involves receiving the scattered electromagnetic signal 506 at the receivers 412. The receivers 412 can be positioned on the in-line inspection device 408. In an example, the receivers 412 can receive the scattered electromagnetic signal 506 that is scattered by the anomaly 508 in the wall 300 of the flexible pipe 200.

At block 608, the process 600 involves inverting data that is indicative of the scattered electromagnetic signal 506. A cost function used in a data inversion may contain three terms: a magnitude misfit, a phase misfit, and a regularization that is used to eliminate spurious non-physical solutions of the inversion problem. An example of a self-calibrated inversion cost function is given in Eq. (1), as follows:

$$F ( x ) = \frac{1}{2 M} {‖ {W}_{m , abs} \times ( \frac{\vert m \vert - \vert {m}_{nom} \vert}{\vert {m}_{nom} \vert} - \frac{\vert s ( x ) \vert - \vert {s}_{nom} \vert}{\vert {s}_{nom} \vert} ) ‖}_{2}^{2} + \frac{1}{2 M} {‖ {W}_{m , angle} \times ( angle \{ \frac{m}{{m}_{nom}} \} - angle \{ \frac{s ( x )}{{s}_{nom}} \} ) ‖}_{2}^{2} + {\vert {W}_{x} \times ( x - {x}_{nom} ) \vert}_{1} \qquad ( 1 )$$

where x is a vector of N unknown model parameters; x=[t₁, . . . , t_{N}_{ₚ}, μ₁, . . . , μ_{N}_{ₚ}, σ₁, . . . , σ_{N}_{ₚ}, . . . ], where Nₚ is the number of pipe layers; m is a vector of M complex-valued measurements at different frequencies and receivers; M=N_{R}_{ₓ}×N_{f}, where N_{Rx} is a number of receivers and N_{f} is a number of frequencies; mₙₒₘ is a vector of M complex-valued nominal measurements, such as computing as signal levels of highest probability of occurrence within a given zone; s(x) is a vector of M forward model responses; sₙₒₘ is a vector of M complex-valued forward model responses corresponding to the nominal properties of the flexible pipes; W_{m,abs}, W_{m,angle} are measurements of magnitude and phase weight matrices, where M×M diagonal matrices are used to assign different weights to different measurements based on a relative quality or importance of each measurement; Wₓ is an N×N diagonal matrix of regularization weights; xₙₒₘ is a vector of nominal model parameters; and for N-dimensional vector y, ∥y∥₂²=Σᵢ₌₁^{N}|yᵢ|² and |_{y}|₁=Σᵢ₌₁^{N}|yᵢ|. Additionally,

$$\frac{s ( x )}{s}$$

is element-wise division. At the core of the inversion is the forward model s(x), which computes a predicted tool response s corresponding to any set of model parameters x. An accuracy of the estimated model parameters may hinge on an accuracy of the forward model.

The receivers 412 can receive the scattered electromagnetic signal 506 after the electromagnetic signal 502 interacts with the wall 300 of the flexible pipe 200. In an example, a dataset can be created from a set of scattered electromagnetic signals 506 received by the receivers 412. The data inversion can be performed on the dataset to create an inverted dataset. Evaluation of the flexible pipe 200 may rely on data inversion for a set of unknown parameters. The unknown parameters may include an individual thickness of each pipe layer, a percentage of metal loss or gain of each pipe layer, an individual magnetic permeability of each pipe layer, an individual electrical conductivity of each pipe layer, a total thickness of all pipe layers, an eccentricity of each pipe layer, an internal diameter of each pipe layer, or any combination thereof.

By comparing a wall thickness, determined from the scattered electromagnetic signal 506, in one location to an adjacent location, or to a historical record, an extent of metal loss can be determined. Furthermore, by selecting which sets of frequencies are inverted, metal loss can be selectively calculated. Additionally, the recovered frequencies can be used simultaneously to determine metal loss in each metallic layer of the flexible pipe 200.

At block 610, the process 600 involves identifying the anomaly 508 along a layer of the flexible pipe 200. The inverted dataset can be analyzed to determine if the anomaly 508 exists. If the anomaly 508 is identified, the process 600 may output the location of the anomaly 508. The output can include information on a radial location and a linear location of the anomaly 508. Additionally, the output can identify a particular layer of the flexible pipe 200 in which the anomaly 508 is located.

In another example, the electromagnetic inspection device having at least one transmitter 410 or receiver 412 is run external to the pipe. Through-pipe measurements may be made along with in-line and external measurements. The measurements are inverted for an individual thickness of each conductive layer of the flexible pipe 200. A combination of in-line and through-pipe measurements may provide greater data diversity for more accurate characterization of individual thicknesses of layers of the flexible pipe 200.

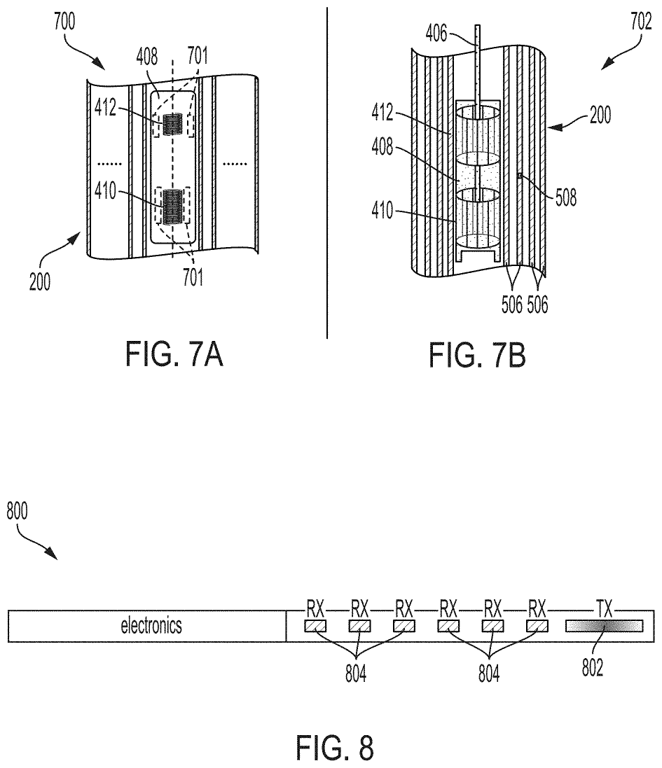

FIG. 7A is a top-level schematic view 700 of the in-line inspection device 408 positioned in the flexible pipe 200 according to one example of the present disclosure. The in-line inspection device 408 can include one or more transmitters 410 and one or more receivers 412. The transmitters 410 can transmit the electromagnetic signal 502, and the receivers 412 can receive the scattered electromagnetic signal 506. The in-line inspection device 408 can be positioned in the flexible pipe 200, and the flexible pipe 200 can include a set of metallic layers 504. The metallic layers 504 can include an anomaly 508, and the in-line inspection device 408 may identify the location of the anomaly 508. In the schematic view 700, the in-line inspection device may not be able to identify the anomaly 508 with azimuthal sensitivity due to coils of the transmitters 410 and receivers 412 being symmetrically wrapped around a longitudinal axis of the in-line inspection device 408 to generate an omnidirectional sensor.

In some examples, the in-line inspection device 408 may also include a shielding 701 applied to one or more of the transmitters 410, one or more of the receivers 412, or both. The shielding 701 can include metallic components that can be positioned on the in-line inspection device 408 for altering the electromagnetic signal 502 from the transmitters 410. For example, the shielding 701 may be fixed such that the transmitters 410, receivers 412, or both only transmit or receive the altered electromagnetic signal 502 from a certain direction. The altered electromagnetic signal may provide azimuthal sensitivity when identifying cracks or other anomalies in the flexible pipe 200 that may not be available without the shielding 701.

FIG. 7B is a schematic view 702 of the in-line inspection device 408 positioned in a flexible pipe 200 according to one example of the present disclosure. The in-line inspection device 408 can be coupled to the umbilical 406. The in-line inspection device 408 can also include the transmitters 410 and the receivers 412. The transmitters 410 and the receivers 412 can be positioned circumferentially on the in-line inspection device 408. In such an example, the transmitters 410 and the receivers 412 can be positioned on a radius equidistant from a central point on the in-line inspection device 408. The in-line inspection device 408 can be positioned in the flexible pipe 200, and the flexible pipe 200 can include a set of metallic layers 504. The metallic layers 504 can include an anomaly 508, and the in-line inspection device 408 may identify the location of the anomaly 508. In the schematic view 702, the in-line inspection device may be able to identify the anomaly 508 with azimuthal sensitivity.

In the schematic view 700 and in the schematic view 702, the transmitters 410, which can be positioned on the in-line inspection device 408, can transmit a signal with a set of frequencies. The set of frequencies can be tuned to correspond to a maximum scattered signal response in respective layers in the flexible pipe 200. A flexible pipe layer location of the anomaly 508 can be detected from a frequency of the scattered electromagnetic signal 506. In some examples, the in-line inspection device 408 can include a bucking coil operable to reduce a portion of the electromagnetic signals 502 transmitted by the transmitters 410 from being detected by the receivers 412. The bucking coil may reduce noisy data received by the receivers 412, which can increase efficiency and accuracy of the data inversion in block 608 of process 600.

FIG. 8 is a schematic view of an electromagnetic inspection device 800 according to one example of the present disclosure. At least one transmitter 802 and at least one receiver 804 can be positioned on the electromagnetic inspection device 800. The transmitter 802 can transmit the electromagnetic signal 502, and the receiver 804 can receive the scattered electromagnetic signal 506. The inspection device 800 is an example of a frequency-domain tool. In the frequency-domain tool, the transmitter 802 and the receivers 804 are located separately to record different channels. The multiple channels recorded at multiple transmitter-receiver distances may provide sufficient information to determine a radial position and an amount of metal loss of each metallic layer of the flexible pipe 200.

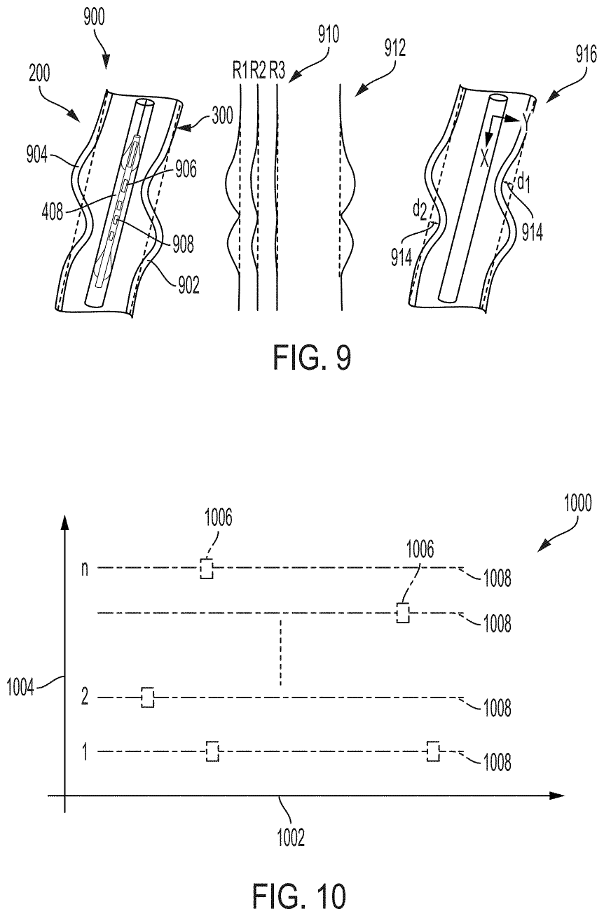

FIG. 9 is an example of the in-line inspection device 408 and outputs from the in-line inspection device 408 including an indication of a deformation in the wall 300 of the flexible pipe 200 according to one example of the present disclosure. A diagram 900 shows a defective flexible pipe 200 with deformations 902 and 904 where the deformations 902 and 904 from an original trajectory are indicated by dotted lines. The deformations 902 and 904 have amplitudes of d1 and d2, respectively. The defective flexible pipe 200 may be logged with an electromagnetic pipe inspection tool, such as the in-line inspection device 408. The illustrated in-line inspection device 408 includes one transmitter coil 906 and three receiver coils 908. A reading 910 from the receivers 908 of the in-line inspection device 408 shows a set of measured responses R1, R2, and R3 recorded by the three receiver coils 908.

A bend in the defective pipe may show up as a deflection in a response from a baseline that is more prominently pronounced in short-spacing receivers than in long-spacing receivers, such as those deflections shown by comparing measurements of the measured responses R1-R3 as in a reading 910. Through joint processing of multi-spacing measurements, a point-wise eccentricity between the pipes can be estimated as shown in a processed reading 912. Bend parameters, such as amplitudes of the bend deformations 914, may be estimated and displayed as a pipe trajectory map 916. Since azimuthally symmetric coils are used in the in-line inspection device 408 of this example, the in-line inspection device 408 does not exhibit any azimuthal sensitivity, and therefore both bends shown in this example may result in deflections in the responses in the same direction.

When constructing the pipe trajectory, both end sections of the log, as in the reading 910, coincide with the baseline. This indicates that the two identified bends must be in opposite directions from the baseline. An absolute direction of each bend and the plane of the bends may not be determined by the azimuthally symmetric in-line inspection device 408. Therefore, the constructed trajectory map in this case is a two-dimensional relative map.

In another example, an in-line inspection device 408 as constructed in FIG. 7B can include a set of transmitters 410 and a set of receivers 412. The transmitters 410 and the receivers 412 can be positioned on the in-line inspection device 408 circumferentially, which means the transmitters 410 and receivers 412 can be positioned on a radial location on the in-line inspection device 408 that is equidistant from a central point on the in-line inspection device 408. The in-line inspection device 408 with the transmitters 410 and the receivers 412 positioned circumferentially may identify deformations 902 and 904, or an anomaly 508, with azimuthal sensitivity.

FIG. 10 is an example output graph 1000 of the in-line inspection device 408 including an indication of an anomaly 508 in the wall 300 of the flexible pipe 200 according to one example of the present disclosure. As the in-line inspection device 408 travels along the flexible pipe 200, a log of each metallic layer can be recovered along an entire length of the flexible pipe 200 to generate the output graph 1000. Examining the output graph 1000, which is an anomaly log, may provide an indication of the location of the anomalies 508 within the flexible pipe. A linear location of an anomaly 508 of the flexible pipe 200 can be given by a horizontal axis 1002 of the output graph 1000. The linear location may represent a depth of the anomaly within the flexible pipe 200. A layer of the flexible pipe 200 on which the anomaly is positioned can be given on a vertical axis 1004 of the output graph 1000. The output graph 1000 can indicate a set of anomalies 1006 at specific linear locations along the flexible pipe 200 and at specific metallic layers of the flexible pipe 200. The output graph 1000 can include a set of gridlines 1008, which can represent different metallic layers of the flexible pipe 200.

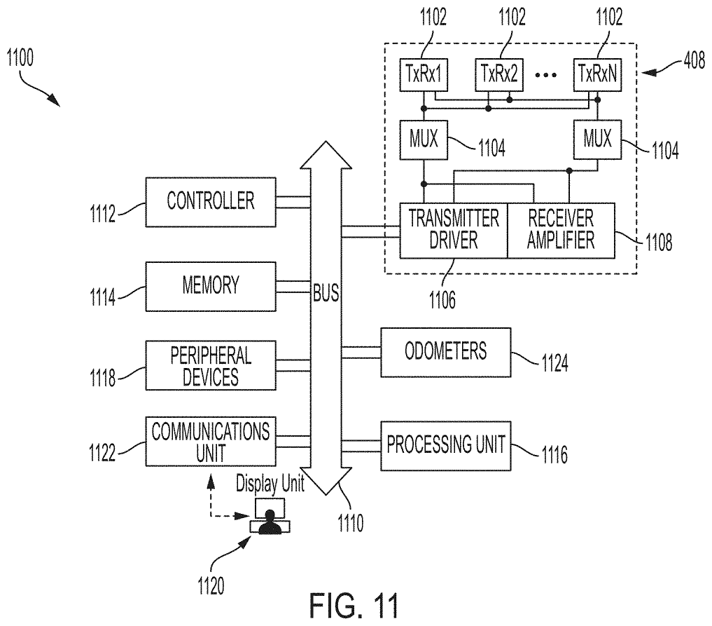

FIG. 11 is a schematic view of a computing system 1100 communicatively coupled to the in-line inspection device 408 according to one example of the present disclosure. The in-line inspection device 408 can include a set of transmitters and receivers 1102, and the set of transmitters and receivers 1102 can be coupled to a set of multiplexers 1104. The set of transmitters and receivers 1102 can receive a set of signals from a transmitter driver 1106 and transmit a set of signals to a receiver amplifier 1108. The transmitter driver 1106 and the receiver amplifier 1108 can be coupled to a bus 1110.

The bus 1110 may transfer data to other components of the computing system 1100. The bus 1110 can include instrumentality for a communication network. The bus 1110 can be configured such that components of an inspection and logging system are distributed. Such distribution can be arranged between the in-line inspection device 408 components and components that can be disposed external to the flexible pipe 200, such as at a surface of a well. The bus 1110 can include an address bus, a data bus, and a control bus, each independently configured. The bus 1110 can also use common conductive lines for providing one or more of address, data, or control, the use of which can be regulated by a controller 1112.

The controller 1112 can be coupled to the bus 1110, and the controller 1112 can manage or direct flow of data throughout the computing system 1100. The computing system 1100 can also include a memory unit 1114. The memory unit 1114 can include one memory device or multiple memory devices. The memory unit 1114 can be non-volatile and may include any type of memory device that retains stored information when powered off. Non-limiting examples of the memory unit 1114 include electrically erasable and programmable read-only memory, flash memory, or any other type of non-volatile memory. At least some of the memory unit 1114 can include a non-transitory computer-readable medium from which a processing unit 1116 can read instructions. The non-transitory computer-readable medium can include electronic, optical, magnetic, or other storage devices capable of providing the processing unit 1116 with the instructions or other program code. Non-limiting examples of the non-transitory computer-readable medium include magnetic disk(s), memory chip(s), ROM, random-access memory, an application-specific integrated circuit, a configured processor, optical storage, or any other medium from which a computer processor can read the instructions. The memory unit 1114 can contain a set of instructions for executing blocks of the process 600, including block 604, block 606, block 608, and block 610. In some examples, the instructions can include processor-specific instructions generated by a compiler or an interpreter from code written in any suitable computer-programming language, such as C, C++, C#, or Java.

The computing system 1100 can also include the processing unit 1116, which can be communicatively coupled to the memory unit 1114 by the bus 1110. The processing unit 1116 can include one or more processors. Non-limiting examples of the processors include a field-programmable gate array, an application-specific integrated circuit, a microprocessor, or any combination of these. The processing unit 1116 can execute instructions contained in the memory unit 1114.

The computing system 1100 can include peripheral devices 1118 such as displays, additional storage memory, or other controlled devices, that may operate in conjunction with the controller 1112 or the processing unit 1116. A display unit 1120 can present diagnostic information for the inspection device according to various examples described above. The display unit 1120 can be communicatively coupled to the computing system 1100, and the display unit can communicate with the communications unit 1122, which can be contained in the computing system 1100. The display unit 1120 can also display a set of information that can include datasets, a linear location of an anomaly 508 in the wall 300 of the flexible pipe 200, a layer location of the anomaly 508 found in the wall 300 of the flexible pipe 200, or any other information associated with the oil and gas offshore installations 100. The communications unit 1122 can include communications for a tethered inspection operation. The communications unit 1122 can also include a wireless telemetry system.

A user interface can be implemented to manage operation of the computing system 1100 or components distributed within the inspection and logging system, in conjunction with the communications unit 1122 and the bus 1110. A location of the computing system 1100 can include a topside facility, such as a platform 402, or the location of the computing system 1100 can be on the in-line inspection device 408. If the computing system 1100 is positioned on the in-line inspection device 408, the computing system 1100 can also include an odometer 1124. The odometer 1124 can track the location of the in-line inspection device 408 while the in-line inspection device 408 is positioned in the flexible pipe 200.

In various examples, a non-transitory machine-readable storage device, such as the memory unit 1114, can include instructions stored thereon, which, when performed by a machine, cause the machine to become a customized, particular machine that performs operations including one or more features similar to or identical to those described with respect to the methods and techniques described herein. A machine-readable storage device, herein, may be a physical device that stores information, such as instructions or data, which when stored, alters the physical structure of the device. Examples of machine-readable storage devices can include, but are not limited to, memory in the form of read only memory (ROM), random access memory (RAM), a magnetic disk storage device, an optical storage device, a flash memory, and other electronic, magnetic, or optical memory devices, including combinations thereof.

The physical structure of stored instructions may be operated on by one or more processors such as, for example, the processing unit 1116. Operating on physical structures such as the processing unit 1116 can cause the machine to perform operations according to methods described herein. The instructions can include instructions to cause the processing unit 1116 to store measurement data or databases such as those databases generated according to methods described herein, and other data in the memory unit 1114. The memory unit 1114 can store the results of measurements of a condition of the flexible pipe 200, as well as gain parameters, calibration constants, identification data, etc. The memory unit 1114, therefore, may include one or more databases, such as a relational database.

In some aspects, systems and methods for inspecting flexible pipes in a hydrocarbon well environment are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: an electromagnetic inspection device, comprising: at least one transmitter positionable to transmit at least one electromagnetic signal toward a plurality of layers of a wall of a flexible pipe for transporting hydrocarbon fluids; and at least one receiver positionable to receive at least one scattered electromagnetic signal from the plurality of layers of the wall of the flexible pipe in response to the at least one electromagnetic signal; a processing device; and a memory device that includes instructions executable by the processing device for causing the processing device to: receive, from the at least one receiver, the at least one scattered electromagnetic signal; and identify at least one anomaly in the plurality of layers of the wall of the flexible pipe using the at least one scattered electromagnetic signal.

Example 2 is the system of example 1, wherein the at least one transmitter and the at least one receiver are positionable circumferentially on the electromagnetic inspection device to provide azimuthal sensitivity in detecting a location of the at least one anomaly.

Example 3 is the system of examples 1-3, wherein the electromagnetic inspection device is positionable within the flexible pipe.

Example 4 is the system of example 3, wherein the electromagnetic inspection device is positionable within the flexible pipe as a tethered pig, free-swimming pig, or a robotic device.

Example 5 is the system of examples 1-4, wherein the at least one transmitter is tuned to transmit the at least one electromagnetic signal at a plurality of frequencies, wherein each frequency of the plurality of frequencies is tuned to an individual layer of the plurality of layers of the wall of the flexible pipe.

Example 6 is the system of examples 1-5, wherein the processing device and the memory device are positionable on the electromagnetic inspection device.

Example 7 is the system of examples 1-6, wherein the instructions are further executable for causing the processing device to: analyze a dataset of the at least one scattered electromagnetic signal using data inversion, wherein the data inversion comprises a self-calibrated cost function.

Example 8 is the system of examples 1-7, wherein the electromagnetic inspection device is operable in a time-domain mode or a frequency-domain mode.

Example 9 is a method comprising: deploying an in-line inspection device a flexible pipe that transports fluids, the in-line inspection device comprising at least one transmitter and at least one receiver; transmitting at least one electromagnetic signal from the at least one transmitter toward a plurality of layers of a wall of the flexible pipe; receiving at least one scattered electromagnetic signal in response to the at least one electromagnetic signal by the at least one receiver from the plurality of layers of the wall of the flexible pipe; generating, by a computing device, a dataset from the at least one scattered electromagnetic signal; and identifying, by the computing device, at least one anomaly in the plurality of the layers of the wall of the flexible pipe using the dataset.

Example 10 is the method of example 9, wherein identifying the at least one anomaly is performed using the dataset analyzed with data inversion.

Example 11 is the method of example 10, wherein the data inversion comprises a self-calibrated cost function.

Example 12 is the method of examples 9-11, wherein the at least one anomaly includes metal loss, eccentricity, or deformation.

Example 13 is the method of examples 9-12, further comprising: detecting, by a shielding positioned on the at least one receiver, an azimuthal location of the at least one anomaly in the plurality of layers of the wall of the flexible pipe.

Example 14 is the method of examples 9-13, further comprising: tuning the at least one transmitter to transmit the at least one electromagnetic signal at a plurality of frequencies, wherein each frequency of the plurality of frequencies is tuned to an individual layer of the plurality of layers of the wall of the flexible pipe.

Example 15 is the method of examples 9-14, further comprising: outputting a linear location of the at least one anomaly using data from an odometer positioned on the in-line inspection device; and outputting a flexible pipe layer location of the at least one anomaly using a frequency of the at least one scattered electromagnetic signal.

Example 16 is a non-transitory computer-readable medium comprising instructions that are executable by a processing device for causing the processing device to perform operations comprising: receiving at least one scattered electromagnetic signal with at least one receiver of an in-line inspection device from a plurality of layers of a wall of a flexible pipe that transports hydrocarbon fluid; generating, by the processing device, a dataset from the at least one scattered electromagnetic signal; and identifying, by the processing device, at least one anomaly in the plurality of layers of the wall of the flexible pipe using the dataset.

Example 17 is the non-transitory computer-readable medium of example 16, wherein the operation of identifying the at least on anomaly is performed using the dataset analyzed with data inversion.

Example 18 is the non-transitory computer-readable medium of example 16, wherein the instructions are further executable by the processing device for causing the processing device to perform operations comprising: outputting a linear location of the at least one anomaly using data from an odometer positioned on the in-line inspection device; and outputting a flexible pipe layer location of the at least one anomaly using a frequency of the at least one scattered electromagnetic signal.

Example 19 is the non-transitory computer-readable medium of examples 16-18, wherein the at least one anomaly includes metal loss, eccentricity, or deformation of the flexible pipe.

Example 20 is the non-transitory computer-readable medium of examples 16-19, wherein a shielding is positionable on the at least one receiver to detect an azimuthal location of the at least one anomaly in the plurality of layers of the wall of the flexible pipe.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
an electromagnetic inspection device, comprising:
at least one transmitter positionable to transmit at least one electromagnetic signal toward a plurality of layers of a wall of a flexible pipe for transporting hydrocarbon fluids; and
at least one receiver positionable to receive at least one scattered electromagnetic signal from the plurality of layers of the wall of the flexible pipe in response to the at least one electromagnetic signal;
a processing device; and
a memory device that includes instructions executable by the processing device for causing the processing device to:
receive, from the at least one receiver, the at least one scattered electromagnetic signal; and
identify at least one anomaly in the plurality of layers of the wall of the flexible pipe using the at least one scattered electromagnetic signal.

2. The system of claim 1, wherein the at least one transmitter and the at least one receiver are positionable circumferentially on the electromagnetic inspection device to provide azimuthal sensitivity in detecting a location of the at least one anomaly.

3. The system of claim 1, wherein the electromagnetic inspection device is positionable within the flexible pipe.

4. The system of claim 3, wherein the electromagnetic inspection device is positionable within the flexible pipe as a tethered pig, free-swimming pig, or a robotic device.

5. The system of claim 1, wherein the at least one transmitter is tuned to transmit the at least one electromagnetic signal at a plurality of frequencies, wherein each frequency of the plurality of frequencies is tuned to an individual layer of the plurality of layers of the wall of the flexible pipe.

6. The system of claim 1, wherein the processing device and the memory device are positionable on the electromagnetic inspection device.

7. The system of claim 1, wherein the instructions are further executable for causing the processing device to:
analyze a dataset of the at least one scattered electromagnetic signal using data inversion, wherein the data inversion comprises a self-calibrated cost function.

8. The system of claim 1, wherein the electromagnetic inspection device is operable in a time-domain mode or a frequency-domain mode.

9. A method comprising:
deploying an in-line inspection device a flexible pipe that transports fluids, the in-line inspection device comprising at least one transmitter and at least one receiver;
transmitting at least one electromagnetic signal from the at least one transmitter toward a plurality of layers of a wall of the flexible pipe;
receiving at least one scattered electromagnetic signal in response to the at least one electromagnetic signal by the at least one receiver from the plurality of layers of the wall of the flexible pipe;
generating, by a computing device, a dataset from the at least one scattered electromagnetic signal; and
identifying, by the computing device, at least one anomaly in the plurality of the layers of the wall of the flexible pipe using the dataset.

10. The method of claim 9, wherein identifying the at least one anomaly is performed using the dataset analyzed with data inversion.

11. The method of claim 10, wherein the data inversion comprises a self-calibrated cost function.

12. The method of claim 9, wherein the at least one anomaly includes metal loss, eccentricity, or deformation.

13. The method of claim 9, further comprising:
detecting, by a shielding positioned on the at least one receiver, an azimuthal location of the at least one anomaly in the plurality of layers of the wall of the flexible pipe.

14. The method of claim 9, further comprising:
tuning the at least one transmitter to transmit the at least one electromagnetic signal at a plurality of frequencies, wherein each frequency of the plurality of frequencies is tuned to an individual layer of the plurality of layers of the wall of the flexible pipe.

15. The method of claim 9, further comprising:
outputting a linear location of the at least one anomaly using data from an odometer positioned on the in-line inspection device; and
outputting a flexible pipe layer location of the at least one anomaly using a frequency of the at least one scattered electromagnetic signal.

16. A non-transitory computer-readable medium comprising instructions that are executable by a processing device for causing the processing device to perform operations comprising:
receiving at least one scattered electromagnetic signal with at least one receiver of an in-line inspection device from a plurality of layers of a wall of a flexible pipe that transports hydrocarbon fluid;
generating, by the processing device, a dataset from the at least one scattered electromagnetic signal; and
identifying, by the processing device, at least one anomaly in the plurality of layers of the wall of the flexible pipe using the dataset.

17. The non-transitory computer-readable medium of claim 16, wherein the operation of identifying the at least on anomaly is performed using the dataset analyzed with data inversion.

18. The non-transitory computer-readable medium of claim 16, wherein the instructions are further executable by the processing device for causing the processing device to perform operations comprising:
outputting a linear location of the at least one anomaly using data from an odometer positioned on the in-line inspection device; and
outputting a flexible pipe layer location of the at least one anomaly using a frequency of the at least one scattered electromagnetic signal.

19. The non-transitory computer-readable medium of claim 16, wherein the at least one anomaly includes metal loss, eccentricity, or deformation of the flexible pipe.

20. The non-transitory computer-readable medium of claim 16, wherein a shielding is positionable on the at least one receiver to detect an azimuthal location of the at least one anomaly in the plurality of layers of the wall of the flexible pipe.
